(19) United States
(12) Patent Application Publication
(10) Pub. No.: US 2009/0242659 A1
(43) Pub. Date: Oct. 1, 2009

(54) INDICATING A SHOWER STAGE

(76) Inventors: Todd Richard Metlen, Ojai, CA (US); Kenneth McLeod Wright, Ojai, CA (US); Veeramuthu Mannierajah, Kedah (MY)

Correspondence Address: SoCAL IP LAW GROUP LLP, 310 N. WESTLAKE BLVD. STE 120, WESTLAKE VILLAGE, CA, 91362, US

(21) Appl. No.: 12/413,421

(22) Filed: Mar. 27, 2009

Related U.S. Application Data
(60) Provisional application No. 61/040,614, filed on Mar. 28, 2008.
(60) Provisional application No. 61/143,117, filed on Jan. 7, 2009.

(51) Int. Cl. B67D 5/08

(52) U.S. Cl. 239/71

(57) ABSTRACT

Processes and apparatus for indicating a shower stage are disclosed. The apparatus includes a housing having an inlet and an outlet with a shower water passage extending between them. The inlet communicates with a water supply and the outlet communicates with shower head apertures. A light indicator system in the housing is automatically operable in a first condition during a first stage of the session and a second condition during a second stage, the lighting conditions being visible to the person who is showering. The stages may be determined by the passage of time or by the passage of shower water volume through the device. Seeing the first and second conditions prompts the person who is showering to use less shower water.

### RELATED APPLICATION INFORMATION

This application claims priority from Application No. 61/040,614, filed Mar. 28, 2008 and entitled “Shower Stage Indicator”, incorporated herein by reference.

This application claims priority from Application No. 61/143,117 filed Jan. 7, 2009 and entitled “Water Usage Monitoring”, incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to water usage monitoring.

2. Description of the Related Art

Water conservation is a major concern in the United States and elsewhere in the world as the demand for water increases while fresh water supplies decrease. According to one prediction, at least thirty-six states will face water shortages within five years due to a combination of rising temperatures, population growths, droughts and waste. In houses, apartment buildings, hotels and the like showers are a major user of water. For example, an average six minute shower uses approximately twenty gallons of water. While “low-flow” shower heads can use as little as 1.6 gallons per minute, they typically use 2.5 gallons per minute. Older (non-low-flow) shower heads, on the other hand, can use as much as five gallons per minute. Additionally, considerable energy is expended to heat the water used in showers. Thus, there is a continuing need to decrease the amount of water used by showers to save both water and energy.

### DESCRIPTION OF THE DRAWINGS

FIG. 1 is a front perspective view of a shower stage indicator device.

FIG. 2 is a rear perspective view of the device.

FIG. 3 is a front exploded perspective view of the device.

FIG. 4 is a rear exploded perspective view of the device.

FIG. 5 is a perspective view illustrating the device installed in an operative position on a shower nozzle and on a water pipe neck.

FIG. 6 is a flow chart of a process for indicating a shower stage.

FIG. 7 is a cross-sectional view of the device.

FIG. 8 is a schematic diagram of a circuit for a shower stage indicator device.

FIG. 9 is a simplified cross-sectional diagram of a shower stage indicator device having a water flow sensor in a first position.

FIG. 10 is a simplified cross-sectional diagram of a shower stage indicator device having the water flow sensor in a second position.

FIG. 11 is a front perspective view of a shower stage indicator device with a Navy mode.

FIG. 12 is a flow chart of a process for indicating a shower stage with a Navy mode.

FIG. 13 is a shower stage indicator device having an impeller-based charger.

FIG. 14 is a perspective view of a shower head having a shower stage indicator.

### DETAILED DESCRIPTION

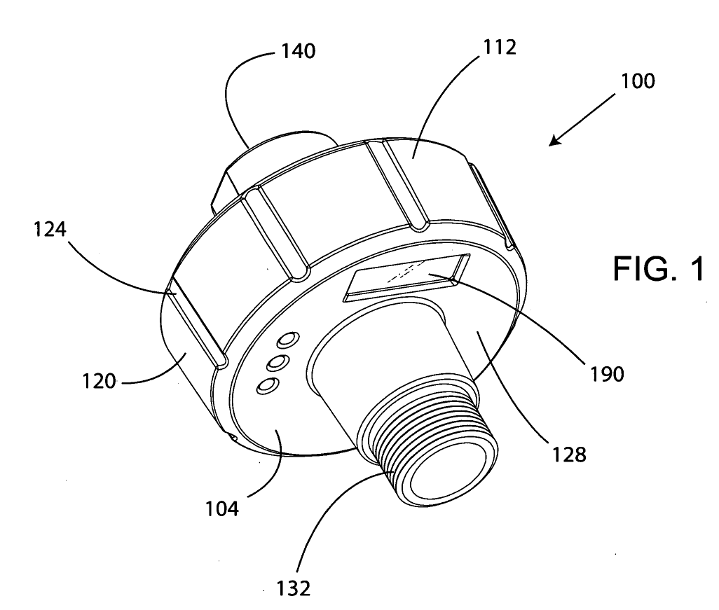

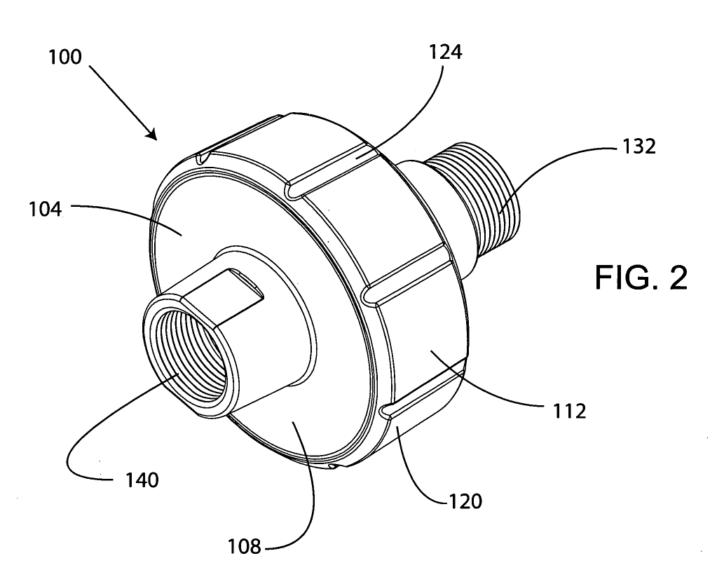

Referring now to FIG. 1 there is shown a front perspective view of a shower stage indicator device 100. The device 100 has a housing 104 having a front housing member 112. The front housing member 112 includes an outer sleeve 120 with grooved friction grips 124, a front face 128, a threaded male connector 132 extending out from the front face 128 and a female threaded connector 140 at the rear. FIG. 2 shows a rear perspective view of the device 100. In this view, a back housing member 108 of the housing 104 is visible.

The device 100 can be retrofitted or new installed into nearly any shower. It is a water actuated timing device which builds conservation habits by signaling the user of a sequence of stages of a showering session. The showering session begins when shower water begins to flow into the device 100 and ends when the shower water ceases to flow into the device 100.

The device 100 has no valves and therefore does not automatically turn off the water. Providing shower stage indication only is advantageous as there may be a need (or desire) for a long continuous shower. For example, consider the situation of a guest in a hotel room. If the guest is showering and the shower water is stopped, this might surprise, frustrate or even anger the guest. On the other hand, gently alerting the guest to the passage of time during the shower will likely encourage the guest to shorten the shower or to alter the guest's showering regime to conserve water and energy. For example, the guest may opt to turn the water off during the soaping/lathering step of the shower regime. This might also encourage the guest to not let the shower run for a long time before getting into the shower.

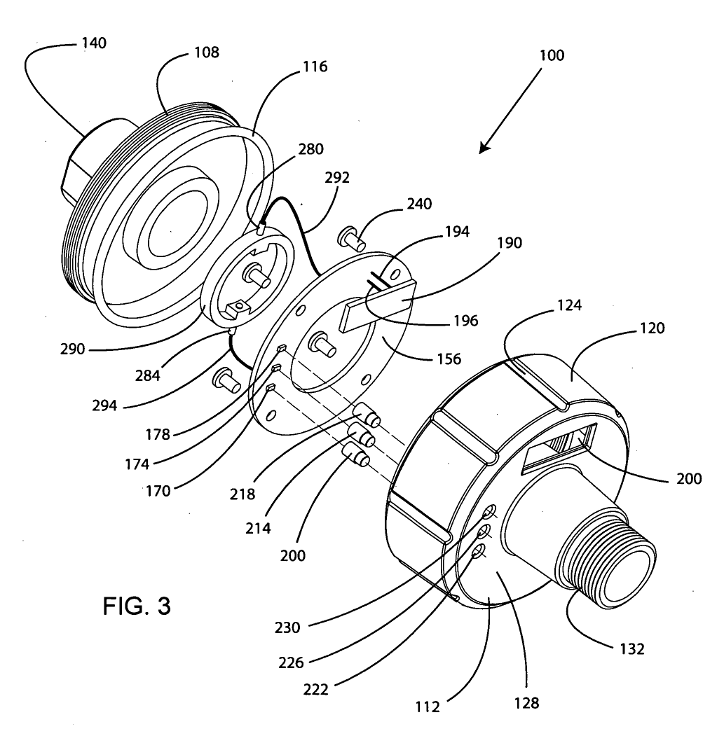

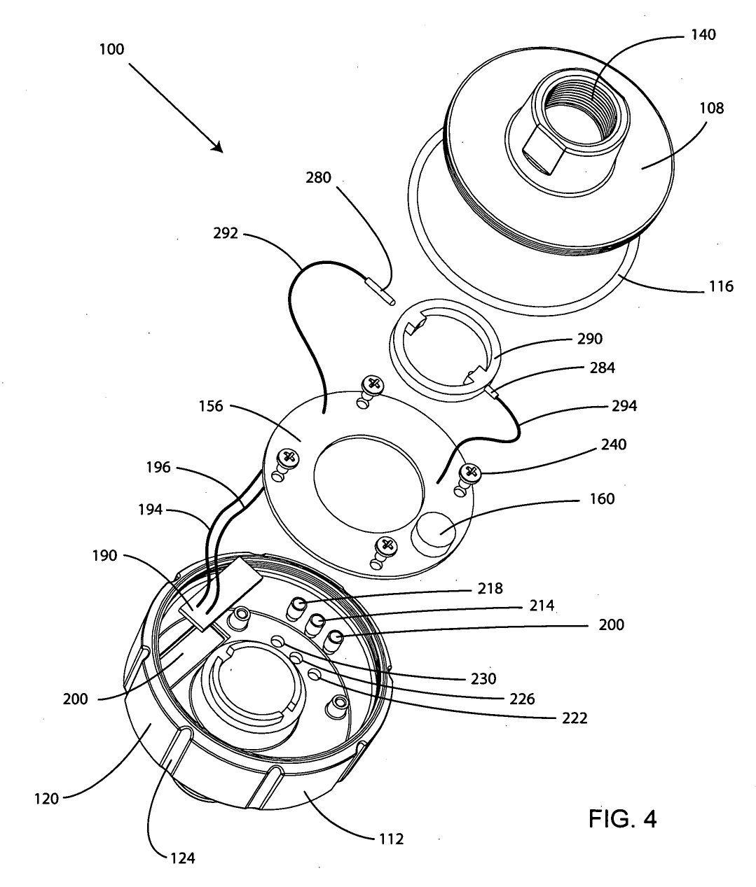

Referring now to the exploded perspective views of FIG. 3 and FIG. 4, the housing 104 of the device 100 may be formed by screwing the back housing member 108 and the front housing member 112 together. An O-ring 116 may be sandwiched between the back housing member 108 and the front housing member 112 to prevent water from seeping into the housing 104. Circuitry and other parts to provide the functionality of indicating a shower stage are mounted on or within the housing 104.

A ring-shaped printed circuit board 156 is mounted within the housing 104 by screws 240. Mounted on the circuit board 156 are a battery 160, green, amber and red LEDs 170, 174, 178, respectively. The LEDs 170, 174, 178 may have respective lenses 200, 214, 218 extending out through a respective opening 222, 226, 230 in the front housing member 112. The on or off state of the LEDs 170, 174, 178 provides a visual indication to the shower user of the stage of the showering session.

The device 100 may include a charging circuit for automatically recharging the battery. If the charging circuit can reliably produce enough power, the battery may be omitted. The charging circuit may include for example a solar cell 190. The solar cell 190 may be mounted in an opening 200 in a front face 128 of the housing 104 or on the outer sleeve 120 of the housing 104. More than one solar cell may be provided to increase the power output and/or to be oriented on another surface of the housing 104 to accommodate different lighting conditions in the shower. Examples of solar cells which may be used are amorphous cells such as are used in solar-powered calculators, and which are well suited for indoor uses. Alternatively, mono-crystalline or poly-crystalline (sometimes called multi-crystalline) cells may be used for example for outdoor resort beach showers. The solar cell 190 alternatively may be mounted on another surface of the housing 104.

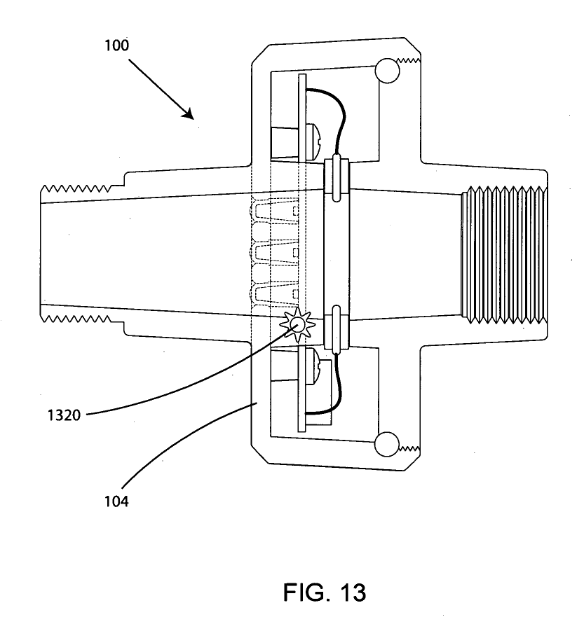

Alternatively to the solar cell or in addition to it, the charging circuit may include an impeller arrangement driven by water flow. Referring now to FIG. 13, an impeller 1320 may be positioned in the water's flow path. The flow of shower water against and past the impeller 1320 causes the impeller to rotate. The rotation of the impeller 1320 drives a micro-generator (not shown) whose electrical output is delivered to the battery 160.

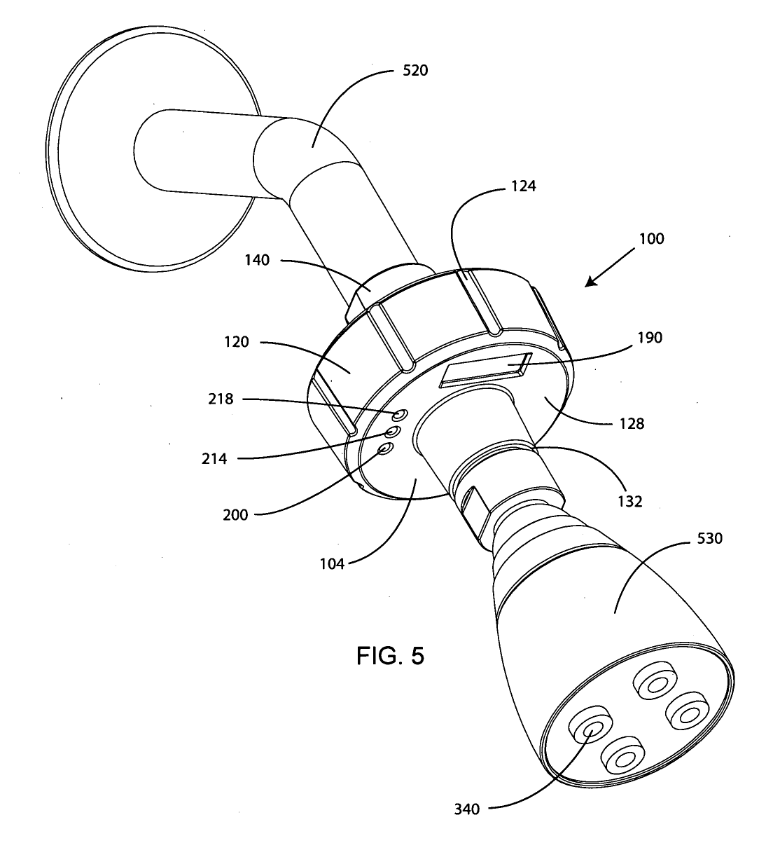

Referring now to FIG. 5, the device 100 may be installed between a water pipe 520 and a shower head 530, by screwing the male threaded connector 132 into the shower head 530 and the female threaded connector 140 onto the water pipe 520. Water flows from the water pipe 520 into and through the device 100, and out the shower head 530.

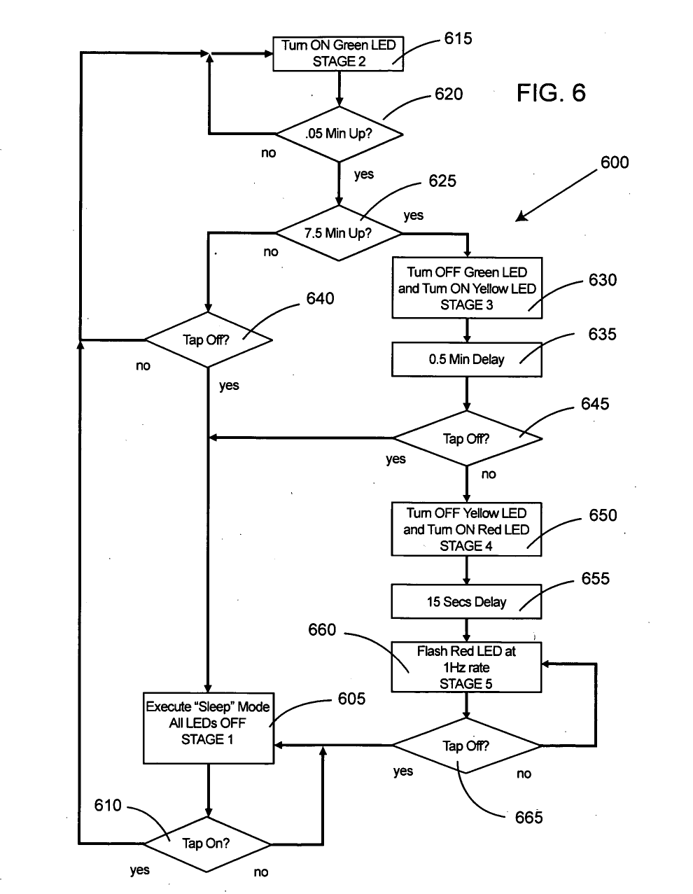

Referring now to FIG. 6 there is shown a flow chart 600 of a process of indicating a shower stage for an 8 minute shower. This process may be provided by the device 100 of FIG. 1. The process starts at stage 1—a sleep mode 605, such as when the water is not running or before the device is even operatively in place.

With the water turned on (“yes” at decision block 610) and the “shower session” begins, stage 2 is met and a green LED light is turned on (block 615). There may then be a short delay, such as 0.05 minutes (i.e., three seconds) (block 620) during which the unit double checks that the water is indeed ON. If the water is running after the short delay, it is assumed that the water was not started by mistake.

After seven-and-a-half minutes in stage 2 (block 625), stage 3 is met and the green light is turned off and a yellow or amber light is turned on (block 630). If the water is turned off during stages 2 or 3 (blocks 645, 640), the system returns to sleep mode 605. After a half minute in stage 3 has passed (block 635), stage 4 is met and the yellow light is turned off and a red light is turned on (block 650).

After fifteen seconds in stage 4 (block 655), stage 5 is met and the red light is operated in a flashing or blink mode (block 660). Because stage 4 is short, process does not include an possibility to return to sleep mode prior to going to stage 5. Stage 5 continues until the water is turned off (block 665), at which time the process returns to sleep mode 605 with all of the lights off.

This process helps people become aware of their personal water usage while showering and gives them a clear indication of when it is time to get out of the shower, that is, to turn the water off and conclude their showering session. There may also be a “thank you” feature. The “thank you feature may be a decorative sequential flashing of all the colored lights in a pleasing way to acknowledge the user's environmentally favorable behavior.

For a five minute showering session, the signaling pattern may be 4½ minutes green, thirty seconds yellow and then flashing red.

The green-yellow-red-blinking sequence is one possible lighting condition sequence. Another option is a count-down arrangement. In the count-down arrangement, stage 1 has all of the lights off. In stages 2, 3 and 4, there a three lights on, two lights on and then one light on, respectively. In stage 5 all three lights are on and are in a flashing or blinking mode either together or in a pattern.

Other indicator options may be utilized. One indicator option is to provide only a single LED that has multi-color modes, such as green, yellow, and red. Examples are LEDs whose color is adjustable by changing the voltage to which they are subjected. Another indicator option is to have the light at each of the stages (except maybe stage 1) at a different blinking or flashing rate. The rates can either increase or decrease from one stage to the next.

The lights may be substituted or embellished with sound generating mechanisms, such as different rates of beeping, or different frequencies or different sound volumes. The final stage of a lighting condition sequence might include a beeping sound. Each of the lighting conditions may be replaced by the sound of a pre-recorded or synthesized voice, advising the user of the stage or the time, even the sound of a man's or woman's voice advising when it is time to soap up, rinse and turn off the water and dry off. An audio signaling system may be used, for example, where the intended user is visually impaired. A pre-recorded voice is useful, for example, for Alzheimer's patients where the voice is that of their care taker.

The times of each of the shower stages are only examples. The length of each stage and the number of stages may be selected based upon water costs, energy costs, nature of the shower, and nature of the users. Additionally, the device may include circuitry and/or software by which the user or the installer can change or select the length and/or number of stages, and/or the lighting conditions for each of the stages. The programmability may be designed to be used as a practical matter only by the installer (e.g., internally or with special tools), or may be designed with external controls (such as buttons) to be used by the user, or some combination of these. For example, for residential use there may be two modes—a “children's mode” with a shorter shower session and an “adult's mode” with a longer shower session. For commercial uses such as in hotel rooms, there may be a variety of lighting condition sessions from which the user may select. The length and/or number of stages may be varied depending on the amount of water flow or the temperature of the water flow. For user programmability, push buttons or other actuators may be provided which a user can use to select from preset timer sequences, for example, three, five or eight minutes, or custom program his own preferred time.

The stages of the showering session may be determined as a function of time, as well or alternatively by the amount of water flow and water temperature. The circuitry, firmware and/or software of the device 100 may implement one or more algorithms to determine which stage the user's shower is in. A temperature sensor may also be included in the device 100 to provide temperature data for the algorithms, so that the algorithms can account for water temperature.

One use of the temperature data is to defer or extend stage 2 until after the water has reached a reasonable bathing temperature. This would be useful for people with showers that take several minutes to get up to temperature due to distance from the water heater or in climates where cold pipes keep the water from getting warm for a long time. The temperature sensor could also be used to give a warning that the water is too hot by flashing all of the signal lights in an alarming way. The temperature data may also be used to dynamically adjust the stage determination based upon temperature of the flowing water.

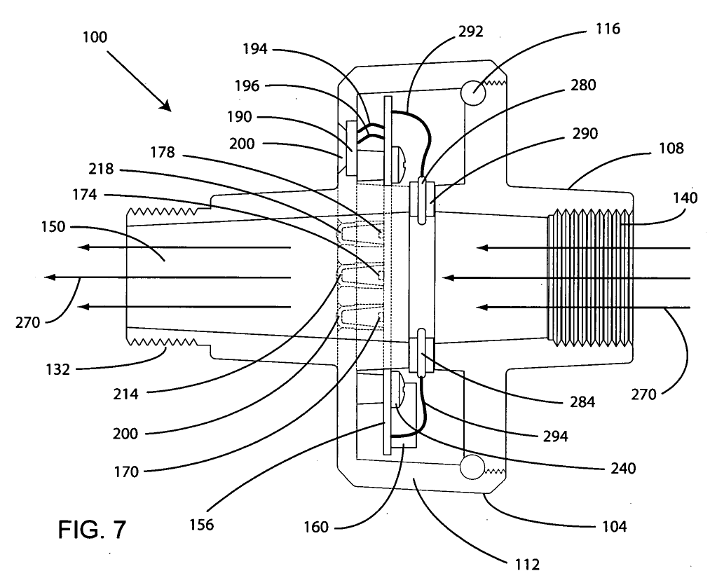

The device 100 may provide a condition detection function to perform the process of FIG. 6. This function may be automatically actuated, at least in part, by the flow of shower water through the device 100. Referring now to FIG. 7, a direction of the flow of the shower water through a passage 150 of the device 100 is indicated by arrows 270. Two contacts 280, 284, making up a water flow sensor, are mounted in respective openings in an insulator ring 290 at spaced locations and are electrically connected by respective wires 292, 294 to the circuit board 156. With the front and rear portions of the housing secured together, the insulator ring 290 is sandwiched and held between the inwardly-mounted support ring of the front housing member 112 and the opposing inwardly-mounted support ring of the rear housing member 108. With the housing members 108, 112 assembled, the openings in the inlet, the outlet, the circuit board 156, the insulator ring 290, the rear-housing member support ring, and the front-housing member support ring are aligned and co-linear, defining the passage 150 for the shower water. When the shower water flows through the passage 150, the electrical circuit between the contacts 280, 284 is completed. Though this may be accomplished with a single contact, there is a risk that a steady drip of shower water along the passage 150 or stagnant water could contact the single contact and thereby actuate the shower stage indication function.

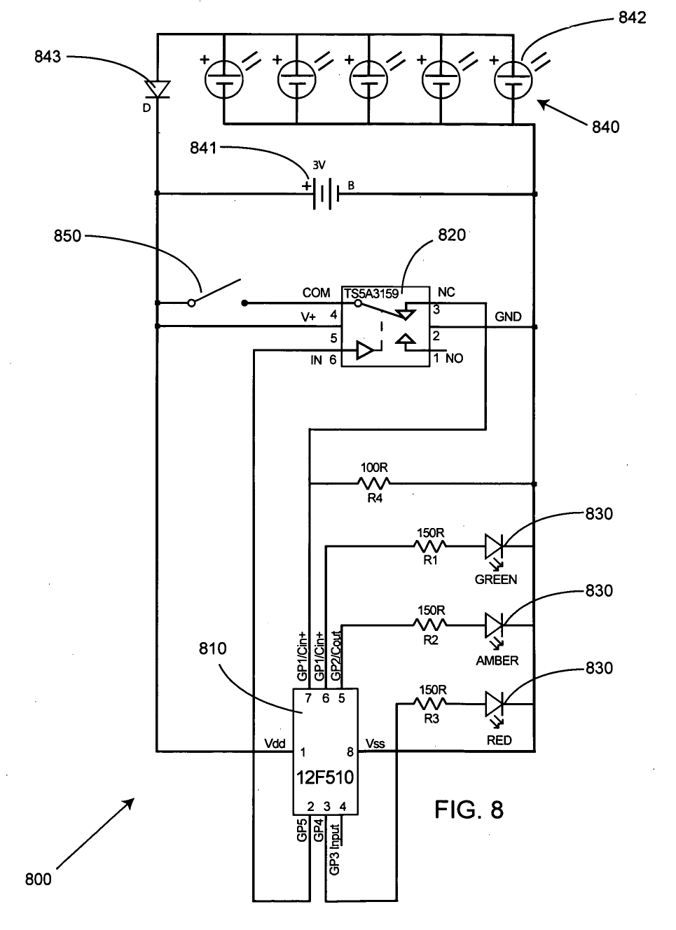

Referring now to FIG. 8 there is shown a schematic diagram of a circuit 800 for a shower stage indicator, such as be the device 100. The circuit 800 includes a controller chip 810, a timing select switch 820, LEDs 830, a power supply circuit 840 and an actuation switch 850. The controller chip 810 has components and/or firmware to implement the algorithms for lighting the LEDs 830. With the timing select switch 820, the circuit 800 may be set for different shower lengths, as described herein. The LEDs 830 may be the LEDs 170, 174, 178 (FIG. 3). The power supply circuit 840 provides power to the circuit 800. Closing of the actuation switch 850 causes the circuit 800 to transition from stage 1 to stage 2. The actuation switch 850 may be the contacts 280, 284 (FIG. 7). The power supply circuit 840 includes a battery 841, one or more solar cells 842, and a diode 843 to control current flow.

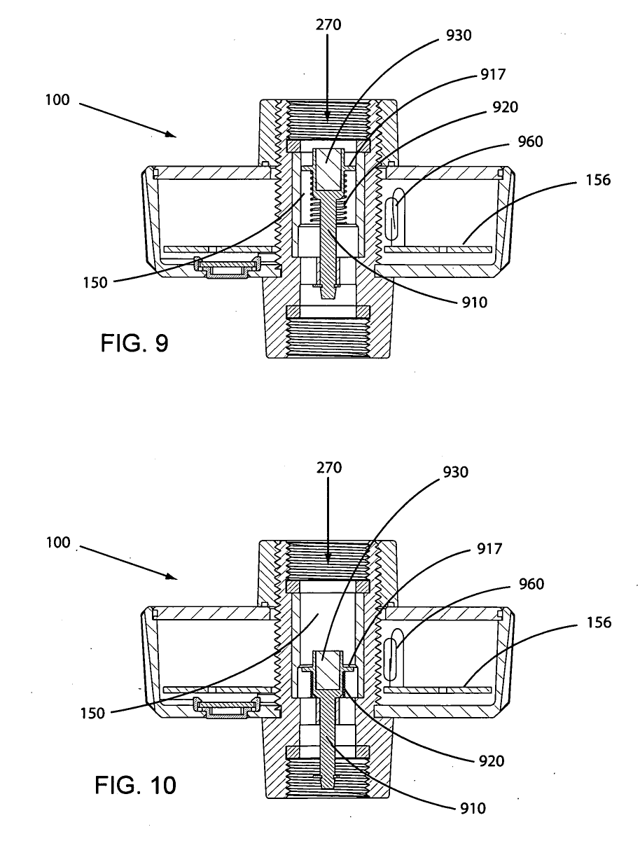

Referring now to FIG. 9, there is shown a cross-sectional diagram of the device 100 having an alternative water flow sensor in the form of a reed switch 960, magnet 930, a spring 920 and plunger 910. Instead of detecting the presence of water as with the contacts 280, 284 (FIG. 8), the flow of water is detected. The plunger 910 has a range of motion in the passage 150. The plunger 910 is biased against the spring 920. A magnet 930 is attached to or integrated into the plunger 910. The reed switch 960 is mounted on the circuit board 156 and is sensitive to the presence of the magnet 930. The reed switch 960 may be the actuation switch 850 (FIG. 8).

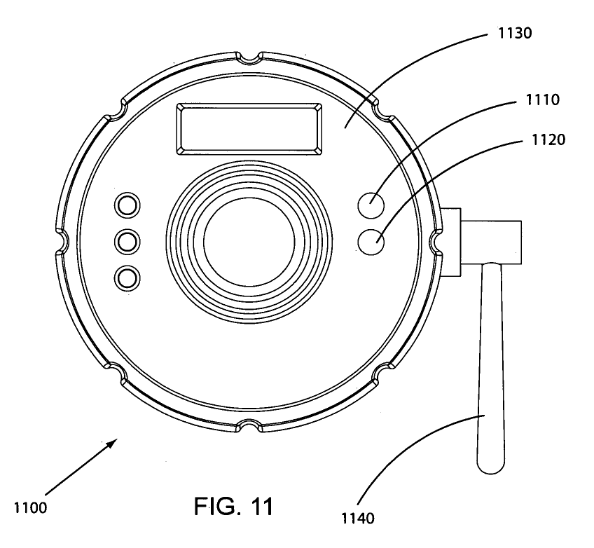

The plunger 910 has a head 917. Water pressure the plunger head 917 moves the plunger 910 from a first position as shown in FIG. 9 to a second position as shown in FIG. 10. When the plunger 910 is in the second position the magnet 930 is close enough to the reed switch 960 to close the reed switch 960. When the reed switch 960 is closed the control circuit is activated and in turn operates the indicators.

When the plunger 910 is in the second position, the plunger head 917 is in a position in the passage 150 which is wider than when in the first position. The shower water thereby can flow around the plunger head 917 and to the shower head. When the water flow is shut off, the spring 920 biases the plunger 910 back to the first position where the plunger head 917 acts as a stopper in the passage 150.

Another alternative is a Navy mode wherein the user temporarily suspends the showering session before completion. This allows the user to turn the water off to shampoo or soap-up without losing on the overall length of the showering session. In other words and for example, a user can take a twenty minute shower but have water flowing for just five minutes. Referring now to FIG. 11, a device for indicating a shower stage 1100 with a Navy mode is shown. The device 1100 is substantially the same as the device 100, so only differences are described. The user can select between normal mode and Navy mode with one or more push buttons 1110, 1120 on the front face 1130 of the device 1100. The push buttons 1110, 1120 may be labeled or otherwise have associated indicia of their purpose. There may also be a manual shutoff handle 1140 connected to a ball valve (not shown) which allows the user to physically cut off the flow of water, the act of which will automatically suspend the timing sequence. Water flow may be suspended in other ways, such as with typical wall-mounted shower valves. The device's controller may provide a reasonable amount of time between being temporarily stopped mid-stage and the water flow resuming. If that amount of time is exceeded, the controller may assume that the user finished his showering session and reset to stage 1.

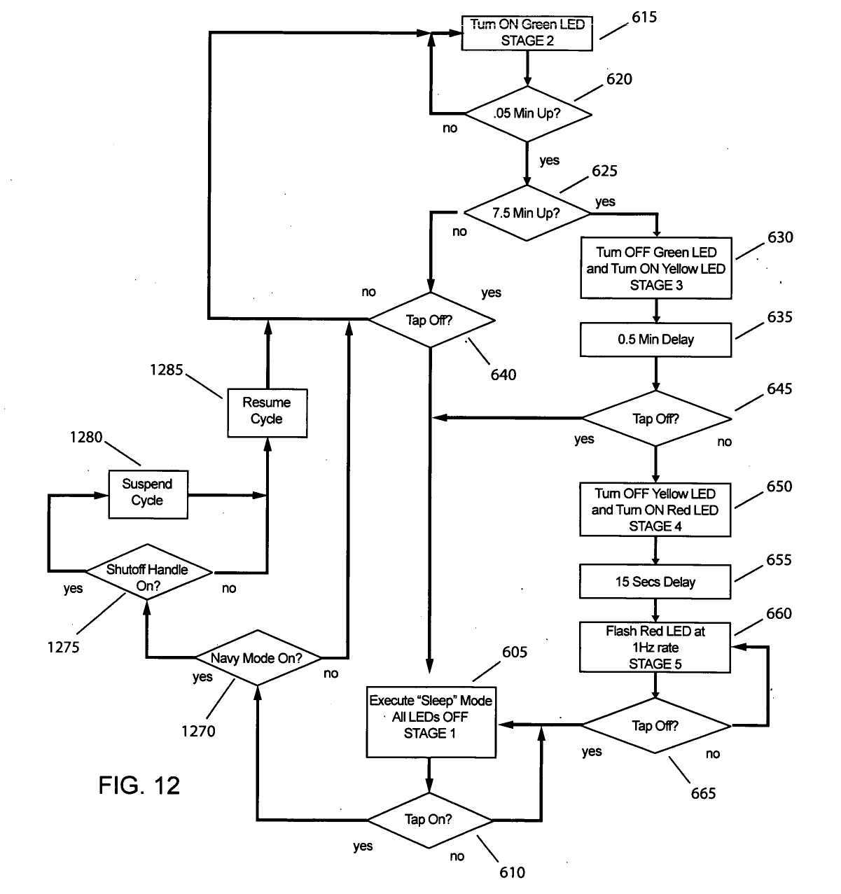

FIG. 12 shows a flow chart 1200 of the operation of the device 1100. The flow chart 1200 is substantially the same as the flow chart 600 (FIG. 6), so only differences are described. Navy mode adds steps 1270, 1275, 180 and 1285 between steps 610 and 615. In step 1270, it is determined if Navy mode is on. If not, then the process continues as in FIG. 6. If Navy mode is on, then it is determined if the water flow has been suspended, such as with the manual shutoff handle 1140 (FIG. 11). If so, then the timer is suspended (step 128) until water resumes at which point the timer resumes (step 1285). FIG. 12 shows detection of water suspension only immediately after water starts, but water could also be suspended at stage 2 or 3, with the timer likewise being suspended. Depending on the length of stage 2, it may be beneficial after stage 1 to stop detecting suspension of water flow. For example, if stage 2 is only 30 seconds, then at stage 2 the shower session is nearly complete and the extra processing of Navy mode may no longer be unnecessary.

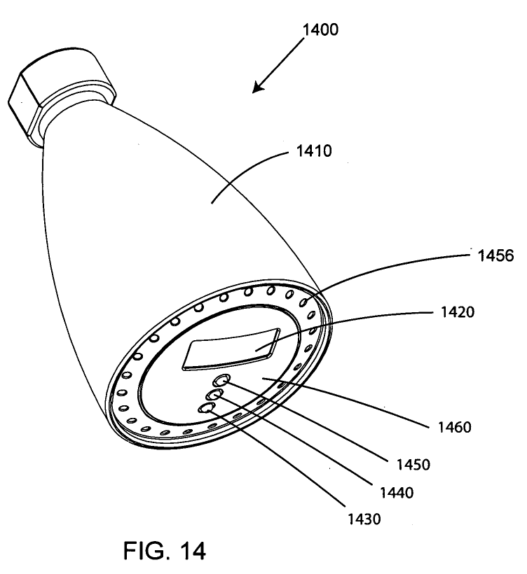

The device 100 may be essentially integrated into nearly any shower head. Referring now to FIG. 14, there is shown a shower head 1400 which also indicates shower stages. The internal components of the device 100 may be disposed internally to the shower head 1400 and protected from or exposed to water as in the device 100. The shower head 1400 has a housing 1410 and a face surface 1460. The face surface 1460 of the shower head 1400 includes a solar cell 1420, three indicator LEDs 1430, 1440, 1450 and a circle of spray apertures 1456. Other arrangements for water spray may be utilized. The internal configuration of the shower head 1400 is comparable to that of the device 100. Generally, any of the alternative constructions or operations discussed earlier for the stand-alone shower stage indicator may be used with the shower head.

The shower stage indication feature may be combined with an automatic water cut-off feature. The stand-alone device or integrated shower head may include a controllable valve which is used to both change the flow of water out of the shower head and thereby also change the spray condition, and also eventually to cut off all flow. An integrated shower head may allow for extra control over spray conditions. With a different shower head spray condition for each shower stage, the shower user has not only a visual indicator but also a sensory indicator and, possibly, an audible indicator.

Signs (not shown) may be proved to explain to a user the shower stage indicators, for example in a hotel bathroom. By noting the shower stages as indicated, a shower user will choose to conserve shower water and energy. This success is expected because considerable success has been realized with the towel laundering procedures of many hotels. That is, many hotels have signs in the bathrooms explaining that to conserve laundering water and energy they will only launder towels and wash cloths which are left on the floor, and most people follow this procedure.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, a “set” of items may include one or more of such items.

Use of ordinal terms such as “first,” “second,” “third,” etc., in the claims to modify a claim element does not by itself connote any priority, precedence or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

1. An apparatus comprising:
a housing having an inlet and an outlet and defining a passage for shower water'
a light indicator system for visually indicating one of plural shower stages of a showering session to a shower user, the shower stages including an off stage, a first stage wherein the showering session has started, and a second stage after the showering session has started and before the showering session has completed'
a circuit in the housing and connected to the light indicator system, the circuit including a water flow sensor, wherein the water flow sensor senses a flow of water into the housing, the circuit for automatically causing the light indicator system to indicate the shower stages in sequence;
a power supply for supplying power to a least one of the circuit and the light indicator system.

2. The apparatus of claim 1 wherein the water flow sensor senses shower water passing along the passage.

3. The apparatus of claim 1 further comprising a shower head having a face surface with a plurality of shower stage indicator lights visible to the user from the face surface.

4. The apparatus of claim 1 wherein the power supply includes a battery in the housing and a charging circuit connected to the battery, wherein the charging circuit is adapted to generate electricity from at least one of ambient light or water flow.

5. The apparatus of claim 4 wherein the charging circuit includes a solar cell generally on the housing.

6. The apparatus of claim 4 wherein the charging circuit includes an impeller operatively positioned in the passage and powered by shower water passing along the passage.

7. The apparatus of claim 1 wherein the first stage has a first predetermined length of time and the second stage has a second predetermined length of time.

8. The apparatus of claim 1 wherein at least one of the first predetermined length of time and the second predetermined length of time is selectable by the shower user before the showering session.

9. The apparatus of claim 1 the circuit having a Navy mode wherein a temporary halt of water flow causes a temporary halt of sequencing of the stages.

10. The apparatus of claim 1 wherein the water flow sensor senses water flowing in the passage.

11. The apparatus of claim 1 wherein the circuit determines the first stage and the second stage based upon an amount of time from when the first stage begins.

12. The apparatus of claim 1 wherein the water flow sensor includes an impeller whose motion by water flowing in the passage determines the first stage and the second stage.

13. The apparatus of claim 1 wherein the power supply includes a battery and a solar cell, the solar cell positioned at an opening of the housing and connected to the battery to recharge the battery.

14. The apparatus of claim 1 wherein the current showering stage includes a third stage after the second stage, and the circuit is for automatically causing the light indicator system to indicate the third stage after the second stage.

15. The apparatus of claim 14 wherein the light indicator system consists essentially of a first lamp to indicate the first stage, a second lamp to indicate the second stage, a third lamp to indicate the third stage, and wherein the off stage is indicated with the first lamp, the second lamp and the third lamp turned off.

16. The apparatus of claim 14 wherein the light indicator system consists essentially of one lamp which has a first color to indicate the first stage, a second color to indicate the second stage, and a third color to indicate the third stage.

17. The apparatus of claim 1 wherein water flow sensor comprises a reed switch and a magnet, wherein proximity of the magnetic causes the reed switch to open or close, and a position of the magnet relative to the reed switch is controlled by water pressure in the passage.

18. A process for indicating sequential stages of a showering session to a user of a shower, the process comprising:
when a first condition has been met, providing a first visual indication to the shower user that the showering session has begun, wherein the first condition comprises initiation of a flow of shower water to a shower head'
next, when a second condition has been met, providing a second visual indication to the shower user that the showering session is intermediate'
next, when a third condition has been met, providing a third visual indication to the shower user that the shower user should end the showering session soon'
next, when a fourth condition has been met, providing a fourth visual indication to the shower user that the user should end the showering session.

19. The process of claim 18 wherein
the second condition comprises passage of a first fixed period of time since the first condition;
the third condition comprises passage of a second fixed period of time since the first condition;
and the fourth condition comprise a third fixed period of time since the first condition.

20. The process of claim 19 wherein
the first fixed period of time excludes periods of temporary water flow cessation;
the second fixed period of time excludes periods of temporary water flow cessation;
the third fixed period of time excludes periods of temporary water flow cessation.

21. The process of claim 18 wherein
the first visual indication is a green light;
the second visual indication is a yellow light;
the third visual indication is a red light;
the fourth visual indication is a blinking red light.

22. Apparatus for indicating sequential stages of a showering session to a user of a shower, the apparatus comprising:
a water supply inlet adapted to communicate with a water supply;
an outlet adapted to communicate with apertures of a shower head;
a passage from the inlet to the outlet;
an indicator system including at least one lamp, the indicator system having at least a first lighting condition for indicating a first stage of the showering session and a different second lighting condition for indicating a second stage of the showering session, the first and second lighting conditions being visible to the user during the showering session.

23. The apparatus of claim 22 wherein the indicator system includes a timer and the timer is actuated by shower water flowing in the passage, and the timer when actuated determines the first stage and the second stage.

24. The device of claim 22 wherein the indicator system has a third lighting condition for indicating a third stage of the showering session.

25. The device of claim 22 including shower head.
